(19) United States
(12) Patent Application Publication
(10) Pub. No.: US 2006/0129522 A1
(43) Pub. Date: Jun. 15, 2006

(54) Subscription service for access to distributed cell-oriented data systems

(76) Inventors: Heiko Gunther Itterbeck, Russelheim (DE); Wolfgang S. Kechel, Idstein (DE); Karl Kipry, Wiesbaden (DE)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/297,988

(22) Filed: Dec. 9, 2005

Related U.S. Application Data
(60) Provisional application No. 60/634,732, filed on Dec. 9, 2004.
(60) Provisional application No. 60/665,918, filed on Mar. 28, 2005.

(51) Int. Cl. G06F 17/30

(52) U.S. Cl. 707/1

(57) ABSTRACT

A cell-oriented data system in which memory cells contain data. A preferred method for storing data in the memory cells includes: receiving at least one datum for storage in the data system; storing the datum in a variable cell that is configured for storing data; and assigning at least one of a plurality of cell data type descriptions to the variable cell. The variable cell is preferably linked to at least one directory cell and at least one linking cell that are used to group a plurality of cells in a hierarchical order. Cell based access to the stored data through any appropriate communication protocol, such as HTTP, can be obtained by using URIs that represent addresses of the data contained in particular cells. Cell based data storage can be made available through a variety of fee based services that benefit from the fine granularity provided by the cell structure.

### CROSS-REFERENCE TO RELATED APPLICATIONS

This application claims the benefit of U.S. Provisional Patent Application Nos. 60/634,732, filed Dec. 9, 2004, and 60/665,918, filed Mar. 28, 2005, both of which are incorporated herein by reference.

### BACKGROUND OF THE INVENTION

1. The Field of the Invention

This invention relates to data storage methods and related systems, methods, and computer program products for storing data in distributed memory cells for real-time communication between one or many nodes.

2. Background and Relevant Art

As computerized systems have increased in popularity, so also have the needs to distribute files and processing resources of computer systems in networks both large and small. In general, computer systems and related devices share information over a network for a variety of reasons, whether, for example, to simply exchange personal electronic messages, to sell merchandise, provide account information, and so forth. One will appreciate, however, that as computer systems have become increasingly more sophisticated for individual use, the challenges associated with sharing data and resources on a network have also increased.

Presently, there are a variety of communication protocols for providing ubiquitous data access; and these protocols tend to serve a wide range of needs. Among these, cell-oriented communication utilizes a memory cell on a technology server to store and retrieve data. The memory cell can be of any type or format, allowing any sort of data, from simple integral numbers to complex video/audio streams to be stored and retrieved. If necessary, history can also be added to any memory cell. Unfortunately, cell-oriented communication cannot be established easily, nor can it be administered and/or controlled in a meaningful way. In many scenarios cell-oriented communication can be difficult to implement, especially where real-time services are needed.

Accordingly, an advantage in the art can be realized with systems, methods, and computer program products that allow cell-oriented communication to be fostered easily among one or more users, and that efficiently foster real-time communication of the same.

Using real-time data in an efficient manner in various applications has been a demand for a long time. Typical target applications have been process monitoring and control systems as well as information systems. Nowadays, a new class of internet based applications arose that need efficient and easy-to-use access to real-time data. When using these systems, the consumer typically knows exactly which data items he is interested in. Traditional solutions used so-called real-time databases. In general, those databases are implified relational databases that have been optimized by omitting a lot of functionality of relational databases to reduce response times for client applications. This approach works to some degree, but due to the lack of standardization concerning data formats and access methods, application development is cumbersome and expensive and is usually tied to a specific database.

Other approaches with specialized applications stuffed as ‘application server’ behind a web server have other severe drawbacks. Applications are again tied to a specific implementation and—even worse—client applications need to connect to a web service using a standard protocol and they need to contact the application server via a proprietary protocol. This design requires additional skills concerning network management and is hard to manage when security becomes an issue. A severe drawback of traditional approaches is the lack of a standardized data model and data access method when one application needs access to multiple services providing different data.

### BRIEF SUMMARY OF THE INVENTION

The present invention solves one or more of the foregoing problems in the prior art by providing a uniform data model for memory cells storing information, a uniform access method for every memory cell, and a data subscription mechanism for memory cells using a cell-based communication architecture. The data storage subscription services can be provided using systems, methods, and computer program products configured to implement universal resource identifiers (“URIs”) with cell-based communication. In one implementation, URIs provide one or more users with access to cells using a simple, commonly used communication protocol in a highly configurable way.

The present invention can be implemented as a web server that provides a publishing mechanism for data items that change over time. Based on robust web technology, the systems provide a framework to extend the server with modules providing services beyond standard web server capabilities. This is accomplished in part via a flexible concept of server extension modules. The systems also come with a set of modules that allow data to be published from various external data sources as producers to the Actual Data Image (ADI) and allows consumers to access this data from everywhere in the world via HTTP calls. The HISTO-module supports access to data archived in a primary data server itself or in external databases.

Functionality provided by the inventive modules can be accessible via HTTP-calls and can be used by consumer applications via simple HTTP-calls exchanged with the primary server. A standard access method allows for a uniform view of the data, even from different underlying data producers and thereby simplifies application development. By reducing the time to market for consumer applications of information systems, embodiments of the invention provide the perfect server portal for this class of application. By allowing access to data changing over time, the invention even opens up the door for new applications using low to medium bandwidth connections to the server and providing access and interaction capabilities formerly not available. Standard office applications as well as high end dynamic data visualization platforms are now able to use the inventive functionality on a wide range of platforms from the high-end desktop to portable devices like smartphones.

Its modular design and modern technology makes the invention a scalable service to publish data from various underlying systems, for example from database management systems, field busses, or from any other of the numerous data management and communication systems known in the art by hiding all low level communication peculiarities. A powerful API and well designed integration interfaces make the invention suitable for a stepwise integration into existing IT infrastructures. Access to information published via the invention can be extended step by step starting with a web browser that displays data presented in HTML pages. Office applications that use URLs as links to access information and customized legacy applications that allow tailored operations to be performed with and on the data may complete the user's toolbox.

The data storage subscription service is based, for example, on a cell-oriented communication system that involves creating a memory cell, and assigning a “type” (e.g., floating point number) to the cell, as well as access rights. Access rights can include “read” rights and “write” rights for different users. With the creation of the cell it has a well-defined URI that allows the owner and other users to access the cell using one or more standard communication protocols. For example, any authorized user (and/or owner) can access the cell using the URI with a standard communication protocol, such as hypertext transfer protocol (“HTTP”). Other users (i.e., “read users”) can poll the URI using HTTP to retrieve the data, and can also register/subscribe to the cell for automatic updates whenever the data in the cell changes. By contrast, users with “write” permissions (i.e., “write users”) can write initial or changed data into the cell over HTTP, which allows other users to receive update events or new data.

By utilizing a standard protocol such as HTTP, almost any device (e.g., personal computers, mobile telephones, personal device assistants), and even embedded devices with network connectivity, including navigation systems in cars, information terminals at public places, or home or professional appliances can be easily connected into a networked information system. Furthermore, due to the nature of the cell-based communication architecture, a one-to-one, one-to-many, many-to-one, and many-to-many communication path is feasible.

Accordingly, aspects of the present invention allow cell-oriented communication to be used as the ultimate platform for a broad variety of business applications and provide the foundation for a data storage subscription model that is flexible and enables subscribers to access a wide variety of information.

Accordingly, a first example embodiment of the invention is a method for storing data in a cell-oriented data system in which memory cells contain data. The method generally includes: receiving at least one datum for storage in the data system; storing the datum in a variable cell that is configured for storing data; and assigning at least one of a plurality of cell data type descriptions to the variable cell.

Another example embodiment of the invention is a method, in a cell-oriented data system in which memory cells contain data, for providing a subscription service that enables users to access the data. This method generally includes: granting a subscriber access to the cell-based communication system; assigning a uniform resource identifier (URI) as an address that represents a datum stored in a memory cell of the cell-oriented data system; and in response to receiving a request that includes the URI, transmitting the requested datum using a web server to a communication device operated by the subscriber.

These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a generic schematic diagram of a cell-oriented memory server configured for hosting one or more memory cells for access through one or more corresponding URIs;

FIG. 2 illustrates a schematic diagram of instances for handling incoming and outgoing communication with the cell-oriented memory server illustrated in FIG. 1;

FIG. 3 illustrates a functionality layer diagram according to an example aspect of the invention; and

FIG. 4 illustrates a system architecture in which example embodiments of the invention can be practiced.

### DETAILED DESCRIPTION OF THE PREFERRED EMBODIMENTS

The present invention provides powerful systems and methods, for example embodied in a web server enhanced with specific modules, that enable fast and easy access to stored data. Data of any type, such as text, number, voice or other audio, photographs or other images, video, and others, can be accessed by a client that directed storage of the data or exchanged like a mailbox with timestamps. By way of example, data cells can be created, stored and accessed on the inventive web server from any device which supports IP protocols, using a familiar web interface.

More particularly, the present invention extends to data storage subscription methods and associated systems, methods, and computer program products configured to implement universal resource identifiers with cell-based communication. In one implementation, URIs provide one or more users with access to cells using a simple, commonly used communication protocol in a highly configurable way. Examples of cell-based communication systems that enable the data storage subscription methods to be implemented are described below, followed by details regarding the subscription services.

I. Cell-Oriented Data Systems

In general, and as described in greater detail below, the cell-oriented data systems that can be used with the subscription services of the invention use memory cells that are addressed with URIs. Thus, a URI used in the cell-oriented data systems represents an address for a specific datum. The URI becomes valid when a cell is created and remains operational while the cell exists. Operations with respect to a particular datum or a memory cell, such as create, read, write, or destroy operations, can be performed using a URI transmitted by HTTP. The memory cells are typed with respect to the data that can be contained therein (e.g., integer, floating-point, text, audio, video, etc.). Each memory cell can contain the associated datum as well as administrative information, such as the identity of the owner, the time of the last change of the datum, etc. Because the data of the memory cells are addressable using URIs, the functionality of the cell-oriented data systems is accessible via conventional web servers. The data of the memory cells can have a specified lifetime, after which the data is destroyed or is otherwise not accessible. As described in greater detail below, the ability to adapt conventional protocols and existing communication infrastructure for the purposes of accessing specific data associated with memory cells represents a significant advantage of the subscription services of the invention.

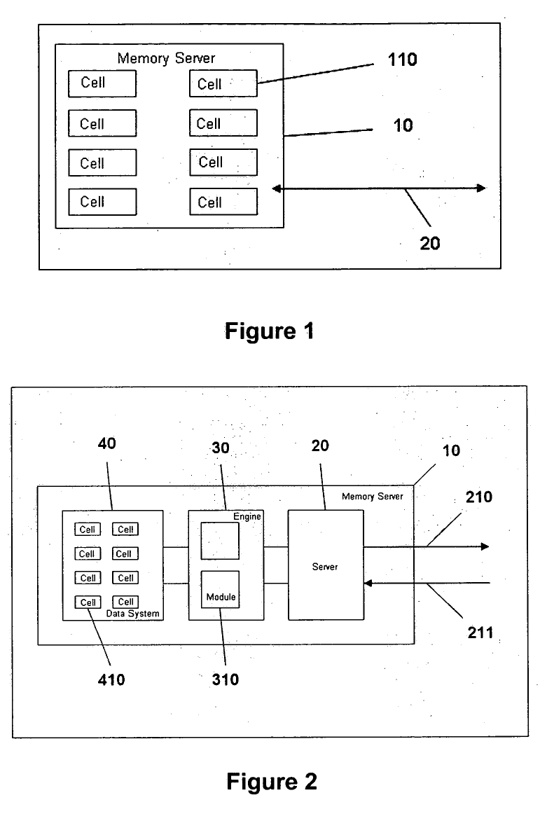

FIG. 1 illustrates the generic schematic diagram of a cell-oriented memory server 10 hosting any number of memory cells 110. The size of the cell-oriented memory server can vary from a couple of hundred cells to several millions or even billions of cells, depending on the end use. As such, implementations of the invention allow for scaling of up to several millions of cells without any significant problems.

Each of the cells can be accessed using a universal resource identifier 20. In general, URI 20 describes the location of the memory cell to be accessed (server, location on server 10), and also carries any relevant information about how to interpret the stored data. For example, the URI can identify whether the referenced data to be accessed in cell 110 is considered to be handled as plain text, numeric, voice or audio, video, etc, and can also indicate the accessing method, such as read, write, delete, etc. Thus, the URI represents an address of a particular datum associated with the referenced memory cell, which can be a real-time datum. The memory cell can contain real-time data or content of essentially any type (e.g., number, text, images, video, audio, voice message, abstract data structures, etc.).

FIG. 2 illustrates instances for handling incoming and outgoing communication with the cell-oriented memory server illustrated of FIG. 1. In particular, to handle the special, often real-time needs for updating, reading, and publishing data, the server 10 is configured to handle any number of communication instances. Cell data, in turn, is viewed by a user using any number of applications capable of reading data through a URI. For example, with standard protocols such as HTTP, a browser would suffice.

An essentially unlimited variety of applications of this technology is possible. As an example, in case the datum is a GPS coordinate, a topographic viewer can be used to view the datum (versus a simple number string in a HTTP). In another example, “heart monitor” information can be viewed using special graphics for a medical application. As such, implementations of the present invention are particularly useful for these and other location based services, whether in relation to the availability of hotel rooms, restaurants, parking spaces, or even the physical location of friends, pets, and so forth.

As shown in FIG. 2, incoming requests are commonly handled by a server 20 that receives read URIs 210 and write/delete URIs 211. After validating the URIs 210 and 211, the server 20 hands the URIs over to a sequence of “modules” 310 bundled in a post-processing engine 30. In general, the modules 310 can act as an interface to the memory cell data system 40, which is configured for hosting the individual memory cells 410. In one implementation, the module 310 is configured to convert the “outward” communication from server 20 into a format suitable for the cell data system 40. The number of modules can be one or many in order to allow one or multiple data paths into the data system 40, and can also be configured for a wide variety of access means. For example, unified data access may be implemented using a hypertext transfer protocol secure (“HTTPS”), whereas real-time data can be fed into the cell data system using an open connectivity (“OPC”) server and a specialized OPC module. Thus, any sort of adapting module can be added, depending on the specific use case.

The server 10, in turn, includes a standard interface, which provides access to the components of server 10. In one implementation, the server provides simple, ubiquitous access to cells 410 through HTTP or HTTP secure. Other servers, such as an OPC server (not shown), or structured query language (“SQL”) database server (not shown), can be used for other types of data, or for different access methods due to other specialized needs.

In any event, the cell-oriented data system 40 can provide a wide variety of functions including, for example, rights management based on any combination of: user name/type; time of access; frequency of access; and/or operation (read/write/delete). Other examples include: real-time data storage and retrieval (i.e., fast location and access of a single cell, in contrast with SQL databases, which focus primarily on more or less complex queries); history for individual cells; and support for a vide variety of data types, such as plain text; numeric data; audio data; video; and geographic data.

U.S. Provisional Patent Application Ser. No. 60/634,732, entitled “Global Data Services,” describes additional details and features of a cell-oriented data system that can be used with the subscription services of the present invention, and is incorporated herein by reference.

Aspects of the foregoing cell-oriented data systems, therefore, provide for a number of advantages. For example, a cell-oriented data system with a simple and standardized access method like HTTP allows for the creation and offering of many new types of services. In particular, applications that can be used with the present invention range from location based services, fleet management, chat and other community applications, to monitor and control scenarios, etc. Services such as these, and other related applications, can all be used without the need of specialized front ends or user interfaces, at least in part where HTTP is being used. For more specialized or restricted applications, dedicated interface applications can be provided, such as specialized cell phone viewers, embedded plug-ins, and so forth.

In addition, a dedicated cell-oriented data system having upwards of billions of cells without compromising access speed, allows for the hosting of real-time monitoring applications. For example, implementations of the present invention can be used in at least two different scenarios that are offered by way of example only: to monitor and control an industrial plant, and to provide location based services in a GIS/navigation system (i.e., providing position specific information about parking availability).

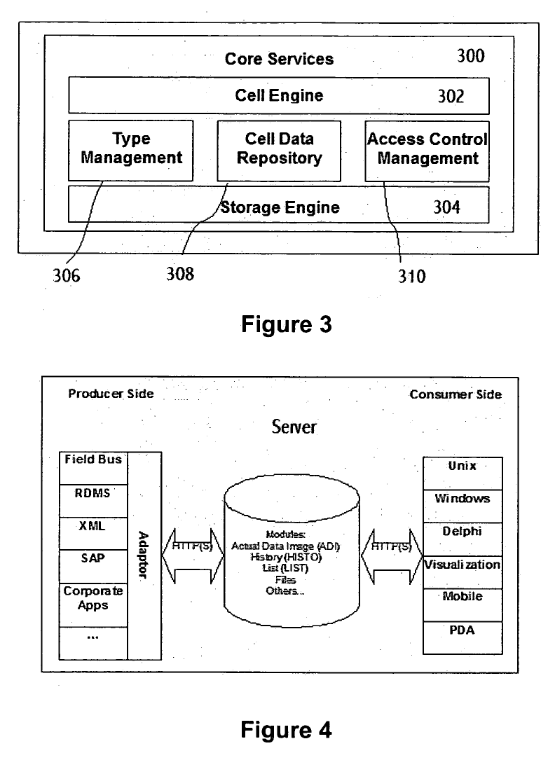

More particularly as described below, the inventive system provides its services organized in a modular fashion. With reference to FIG. 3, the inventive system can provide core services 300 including a cell engine 302, a storage engine 304, and type management 306, cell data repository 308, and access control management 310 modules. FIG. 4 illustrates more directly how the inventive system embodied in a server is securely interposed in a communication environment between content created at a producer side and a consumer side where data is typically accessed. The server may include various modules as described below.

The core functionality is a cell oriented architecture that allows a user to store and retrieve data in data cells that are organized in a hierarchical manner as directed. The core services 300 support variable, directory, link, and proxy cells. Variable cells are used to store the data. A type repository (see below) allows a user to define new types for variable cells. Every variable cell provides a set of attribute slots. A data type is a definition of the order of the attribute slots and their data type. The invention provides various attribute types from simple types (like integer or float number) to complex binary data stored in blobs (Binary Large Object) encoded with a MIME type. Variable cells may be used to exchange data with external systems and allow for bidirectional transfer of data. Aspects of the invention flag variable cells as local or external. Whenever the attribute sval (scheduled value) of a variable cell marked as external is written, the system stores the new data value and keeps it for later retrieval by an external adapter.

Directory cells are used to group other cells (directories, links, proxy and variable cells). A parent-child relationship exists between directories and their entries.

Directories and variables alone form a directed graph. The graph formed via directories and variables can be referred to as the physical tree. Link cells are used to create a link to other cells of any kind and can be placed in a directory like a variable or a directory. Adding links to a physical tree converts the link into a graph. Links allow the system to group other items in a logical way and are used to build a logical view of the physical tree. Generally speaking, links are references. Like references, links introduce several problems: first they may introduce loops into the graph and they might point to non-existing other nodes in the tree (dangling links). Embodiments of the invention therefore check for loops by limiting the maximal number of consecutive links and the maximal number of links that are allowed to be dereferenced when an item is retrieved.

Proxy cells provide access to data that is not stored primarily by the system. A proxy cell contains information about how to acquire the information from an external source (fetch instruction) together with a description about how this information should be structurally mirrored in the inventive cell hierarchy. An example usage of proxy cells is to acquire data from an external source, i.e. an external information system and stuff the data for uniform access for client applications. Proxy cells contain information about the minimal and maximal lifetime of the information until re-fetch.

Information is stored in variable cells. All cells are organized in a directed graph with directory cells holding the other cells as entries. For the special case when the graph consists only of directory and variable cells the graph is a tree. The invention provides proper functions to create new nodes in the tree and to manipulate or remove existing ones.

A very important part of the cell organization is the localization of the cells. By way of example only, a preferred naming scheme for the invention can be defined by the following recursive rules:
1. The root of the cell tree is called root. The name of the root is “/”.
2. Every entry of a directory cell has a name that is unique in this directory. These names may not contain the character “/”.
3. Every cell can be identified by a concatenation of the name of the cell in the directory that contains the cell, a delimiting character (“/”) and the name of the directory containing the cell. The usage of “/” as delimiter here is arbitrary, any character can be used, but it must be forbidden as part of a name.

The name of a cell is called a pathname. A pathname consists of so-called pathname components. A component of the pathname is the part between two component delimiters “/”. To identify a cell, the pathname is used. This mapping is bijective, i.e. every cell has exactly one physical pathname (that can be deduced from the parent/child relationship along the physical tree) and the name can be used to identify the cell by splitting the pathname into components and verifying the existence of the all-but-last component to be existing directory cells. The final component may be of any cell type. The process of finding the proper cell for a pathname is called pathname conversion. The pathname conversion is responsible for the correct mapping of names to cells. It also needs to handle link cells and proxy cells properly.

Link cells introduce some complexity and render the graph from a tree into a directed graph. To avoid cycles in the directed graph (trees do not have cycles, directed graphs may have them), preferred systems put some limitations on link cell usage: the maximal number of consecutive links during pathname conversion is limited to a fixed number; and during pathname conversion, the systems allow a limited number of consecutive link cells.

Proper mathematical background about the behavior of graphs with these limitations can be retrieved from many books about graph theory. As a result, the graph managed by the inventive can be seen as a tree graph.

All the operations to maintain the cell graph are provided by the cell engine 302. The cell engine 302 provides the mapping of names to cells, treating directories and links appropriately. Directory cells and link cells are used to organize the variable cells hierarchically. Variable cells are used to store the data via their attributes. Proxy cells are functions that acquire data and create a sub-graphs of cells underneath the proxy cell.

Proper calls to create, rename and delete cells under the limitations of the underlying graph structure allow access to every cell in a uniform manner, regardless whether access is read or write. As a result, all data stored in the system, regardless of its original source or its final destination, can be operated on via a single interface with a uniform namespace.

Every variable cell is an instance of a cell data type. A cell data type descriptor holds the description of the cell attributes consisting of a cell data type name and a list of attribute descriptions. The members of a cell data type are always of a primitive type. By way of example only, a few primitive types are listed in Table 1 below.

TABLE 1
Primitive Cell Member Types

| Type Name | Type Code | Length, Meaning |
|---|---|---|
| char | 0 | 1 Byte integer value |
| short | 1 | 2 Byte integer value |
| int | 2 | 4 Byte integer value |
| float | 3 | synonym for double |
| double | 4 | 64 bit floating point value |
| text | 5 | Text of variable length |
| file | 6 | MIME encoded binary data |
| | | (image, audio, video, . . . ) |

Formally, the set T of basic types is specified to be:
T:={char, short, int, float, double, text, file}
   and every attribute a is of one of the primitive member types:
∀a ε A:typeof(a) ε T
   The attribute type description Descₐ is an n-tuple of attribute descriptions with each attribute description being a triple of attribute name, attribute description and attribute data type:
Descₜa:=(ad₁, ad₂, . . . , adₙ)
with
adᵢ:=(name: String, description: String, attributetype ε T)

The inventive systems store all cell data type descriptors in a cell data type map that provides a bijective mapping from data type name to data type id and vice versa. Every entry in this map holds the attribute descriptor for the cell data type. The mapping is stored persistently and proper functions to extend the mapping exist.

A “new” the inventive starts with a mapping table that contains only one data cell type descriptions named ‘DEFAULT’. The descriptor for this type is:
Desc_{DEFAULT}:=(ad₁, ad₂ . . . , ad₆)

with example attribute descriptors shown in Table 2 below.

TABLE 2
Type Description for Variable Cells of Type DEFAULT

| Attribute | | | Type/Type |
|---|---|---|---|
| Descriptor | Attribute Name | Description | Number |
| ad₁ | vid | Variable type identifier. | int/2 |
| ad₂ | aval | Actual value. | depends on type |
| ad₃ | sval | Scheduled value. | depends on type |
| ad₄ | Ts | Timestamp of last | double/4 |
| | | modification of variable | |
| | | in seconds since | |
| | | 1.1.1970 00:00 h GMT | |
| | | (double). | |
| ad₅ | type | Data type number of | char..file/0..6 |
| | | aval/sval | |
| ad₅ | flgs | Flags. | int/2 |

New cell data types can be defined by the user via appropriate API functions. User-defined data cell types are stored persistently as well and are treated like built-in data cell types. Upon startup the inventive system reads in all available data type descriptions from persistent storage. Whenever a new data cell type is defined, the new description is written to persistent storage. To grant or restrict access to data published via the server, the server may provide an elaborate access control mechanism. Such access control is preferably based on the following rules: the server provides means to store owner information via a user identification (userid); the server provides means to store group information via a group identifier (gid) (a group is a collection of users that share certain rights); there is a read, write and execute permission that can be specified for the owner, the group and other users; access permissions may be specified for every cell not only on the user/group/other scheme (basic access) but also for a deliberate other user and/or group (access control lists); and every cell belongs to a exactly one user and one group. Access permissions are checked for every operation on a specific data cell. Access is denied when the requesting user does not have sufficient privileges for the requested operation.

Access control management 310 is also very important. Particularly, access control management is the mapping of access control information onto data cells. Access control information is bound to cells and stored persistently via the storage engine. Operations changing the cell graph do not only modify the graph itself but also keep all access information in sync. Access checking is performed for any node in the graph during pathname conversion.

The systems of the invention need to store various data persistently. Various data storage methods can be used as storage. To hide all the details of storing and retrieving information of the underlying storage system, the invention uses a storage abstraction layer called a storage engine that provides an abstraction of the low level services to store and retrieve cell data, data cell type information and access control information. The storage engine provides storage and retrieval functions for the data cell type descriptors. The storage engine provides means to save and load the data cell type description. The key for this process is the type name. The storage engine also provides storage and retrieval functions for the data cells. The storage engine provides means to save and load all kinds of cells (directories, links, variables, proxies) and the information in the variable attributes. The stored items must be identifiable via the cell name. The storage process properly maintains the data format as well as the administrative information. The storage engine provides means to save and load administrative information for every cell. The administrative information includes the owner of the cell and access rights for the owner, the group of the owner and all access information for other users. The stored items must be identifiable via the cell name.

The storage engine 304 is responsible for providing a bijective mapping from a data cell name to the portion of stored data. All cell data is accessed via the cell name that might denote a physical or logical path to the cell.

Cells are addressed via a pathname. To identify a cell, the pathname is split into components that are subsequently inspected. This process is called name resolution. During the inspection process, cells get loaded from persistent store into main memory. The transactional unit for every operation is a cell. The storage performs the synchronization and arbitration between read and write access to cells. For performance reasons, the storage engine operates with a cache of cells kept in main memory keeping cached entries consistent with the persistent data stored on secondary memory.

The current reference implementation of the storage engine uses the file system of the underlying operating system to store the data and an in memory cache of cells of configurable size that supports caching of administrative data and cell content. The cache is implemented as a write-thru cache. Other implementations of the storage engine may use relational or object oriented databases at their discretion.

The inventive systems provide an optional history mechanism for data cells of type variable. Whenever an attribute of a variable is modified, a time-stamped entry is created for this variable and stored persistently. The size of the history may be configured to be of an arbitrary size. The mechanism is limited by the main memory of the machine and the amount of storage space available on the persistent storage.

The inventive systems provide an API to access its functionality. Among the API functions are those to create, modify and delete memory cells. By using this API clients are not only able to create cells of predefined types but also define their own application specific types and create new data cells being instances of that type. The special cell oriented services of the inventive systems allow a variety of tracing, monitoring and billing features including: frequency of access; origin of operation initiator; and kind of operation (read, write).

Based on its cell oriented architecture, the invention provides a subscription model for its client applications. A subscriber defines a collection of data cells he is interested in. These definitions are kept by the inventive systems during its lifetime. Once this collection is defined, the client gets a unique identifier for this collection of cells. From now on, the client may address the whole collection as one item and ask for data changes or may be informed via an event about data changes.

The functionality of the inventive system has been split up in several functional units each being responsible for providing a well-defined subset of the overall functionality. It is known that applications dealing with real-time data need application-specific functions that operate on the data or are data driven. To support the integration of legacy code, the invention provides a module system that allows extending the core functionality with user defined functions. These functions can be made available for client applications via specialized calls or via the very flexible mechanism of the proxy cells.

The core services can be implemented with a focus on a low bandwidth requirement between client and server. This is a major demand for applications using real-time data since all available transfer technologies provide a fairly limited bandwidth. Things become even worse when the computing power of the client device is limited as well. The unique addressing mechanism of the invention for the memory cells supports the transfer of the pure data with minimal overhead. This strongly separates the invention from other data providing services that deliver their results embedded in a complex structure, i.e. XML that cause a significant overhead. Using the inventive systems, applications only need to take care of the pure data offered in a machine independent format and need not worry about complex data format descriptions that might be required to extract the data from a complex result. Since the amount of data is reduced to a minimum, this allows for more data being transferred in the same time, so shorter update cycles might be used to get the most recent data values of interest.

The invention can be implemented as a uniform way to access data. Since access to real-time data becomes more and more important for highly customized applications, time-to-market and application development costs become significant issues. To allow a simple usage of the inventive functionality, the invention appears to the outside world as a full featured web server. The services are provided in a layered approach with a Core Function Layer providing the basic services and a Presentation Layer supporting the presentation of the data in various other formats.

The Core Function Layer operates as a web server itself. This server is targeted for operation in a secure environment and should only be accessible from trusted machines. It provides: user verification via the well-known HTTP-Cookie mechanism; access to all functions from the inventive API via a standardized URI; function results in ASCII format packaged in a proper HTTP protocol reply containing administrative information in the HTTP message header and the pure function result properly encoded in the HTTP body; and access to data cell attributes of type file in properly MIME-encoded form.

The Presentation Layer is implemented via a standard web server. This server may forward specific calls directly to the Core Function Layer or may decide to provide additional functionality or result formats that might be implemented via the well-known server extension mechanisms (i.e. CGI, PHP, Servlet, and the like). This allows for flexible handling of the inventive functionality and easy fine-tuning for specific demands of applications or devices.

The Presentation Layer is also intended to be the end-point of a secure connection between clients and the invention. The Presentation Layer should be configured to operate as a trusted client of the invention.

II. Data Storage Subscription Services

The schema described above can provide the technological foundation for an inventive business model based on subscriptions for data storage, which includes flexible access control. According to the subscription services of the invention, mobile telephone service providers, telecom service providers, internet service providers, application service providers, business integrators, and other commercial entities can offer their clients memory cells.

Subscribers purchase access to a number of cells of one or more types. Subscribers may also receive a specific URI to manage access to the subscribed memory cells. The server manager may allow the subscribers to purchase additional options like history, multi-media content and so forth In one embodiment of the subscription services of the invention, a user can subscribe to data contained in a single cell or can obtain access to an empty cell to which content can be transferred. The data associated with the memory cells is accessible in a variety of ways, including “read on demand”, by which the subscriber polls the memory cell by initiating an HTTP request for access to data, or an “event driven” model, by which data is sent to the user in response to specified events. The data can be transmitted to a communication device operated by the subscriber using any of various transmission means.

For example, requested data can be sent directly to a communication device using HTTP in response to the request. Alternately, the data can be transmitted via an e-mail that is sent to a communication device of the subscriber.

The financial transactions associated with the subscription can be based on events initiated by the subscribing user, such as a particular amount of money per accessible cell, a periodic subscription fee, for the right to access to specific content in a cell, for each instance of access of a cell, for initiating an HTTP request with a URI for purposes of viewing the content of a cell, for the ability to update data stored in a cell, etc. The details of the financial transactions by which the subscriber pays for access to the cell-oriented data system can vary based on the nature of the data system and the usage patterns of the users.

The cell server manager then provides access in a multi-layered format, such by allowing restriction of the following attributes: user, type of access (read/write . . . ), time and frequency (from when to when and how often), type of content, preferred way to display (e.g. graphs, charts, dynamic graphics etc.), and so on. For example, a user (e.g., a cell owner/subscriber) can hand the URI of one of his or her cells to someone else, permitting access for a specific time or frequency only. This can be used for a private meeting or data exchange. Alternatively, the URI may be handed to a specialized subscription service, feeding the user's cell with specialized data in real time (stock prices, patient's blood pressure, current location, network status, arrival time, etc.). As such, the cell servers can be configured to allow a high number of cells, which can each be specialized for certain types of data, and based on certain subscriber models (stock exchange to brokers, navigational data services to drivers, etc.). Individuals (i.e., cell owners) can then use their cells to receive updates about, for example, a favorite auction, flight availability, as well as personal things, such as oven temperature, and so on.

In addition to the foregoing, the present invention can also be described in terms of additional application-specific contexts. For example, the cell-server can be configured to establish priority for reading or writing to the memory cell, such as by setting a default policy of “first-come-first-serve”, or alternatively, in other orders where specific needs may arise, or with specific classes of users/subscribers. Control of each cell can also be implemented in any number of ways. For example, any URI can be configured to hold a complete access control list (“ACL”) token. The ACL token is then validated as part of the retrieve/store operation, and is checked for user/time/frequency/operation.

For example, user A subscribes to a cell from located at a memory cell provider. User A wants a friend to update the cell with the friend's current physical position (i.e., from a GPS system) but only on a specific day. User A creates a specialized URI holding the friend's ID, the validity time span, and the permitted operation (write) as well as the data type (GPS position). By creating the URI, the ACL is created and access is granted. As previously described, any update to a corresponding cell can then be sent automatically to the relevant cell subscribers. For example, automatic updates can be received using a special URI to indicate that a parking place has become occupied, or that an oven temperature at home has been reached, and so on. Thus, signaling or events in a cell can drive updates.

The following specific examples are also illustrative of possible uses of the described technology within the general context of the present invention.

Mobile data exchange: data can be retrieved using any networked device, such as from a stationary PC at a user's home to a mobile phone or embedded car communication platform.

Stock market: One subscribes to a specific service to keep a cell updated with a specific stock price (in real-time) to allow close monitoring of relevant stocks. Whatever device one uses, due to the general protocol, ubiquitous access is possible.

Navigation: One subscribes to a special navigational package displaying the current parking space availability in the vicinity as part of the navigation display. (one or more authorized subscribers access the same data point).

Location Based Services: Based on location specialized services could be offered, showing “buddies” in the vicinity, accommodations, food and beverage information, fleet management, etc.

Bidding: An auction is run trough a cell. (one or many-to-one or many: all participants have read and write access, history and access control tracks bidders)

Forecast: Messages (traffic/weather etc.) are “broadcasted” through a cell. (l:n as the sender puts the data into the cell and n “subscribers” read from it.

Instant Messaging: A cell is used as a message/mail box or pin board in between two or more people. History can also be provided. Messages can be of any format: text, audio, video, etc.

One can appreciate therefore that cell-oriented communication as described herein can be a powerful and versatile instrument on which to build all sorts of services, and provide a flexible way for representing and accessing data in a widely distributed environment.

Embodiments of the invention include or are incorporated in computer-readable media having computer-executable instructions or data structures stored thereon. Examples of computer-readable media include RAM, ROM, EEPROM, CD-ROM or other optical disk storage, magnetic disk storage or other magnetic storage devices, or any other medium capable of storing instructions or data structures and capable of being accessed by a general purpose or special purpose computer. Computer-readable media also encompasses combinations of the foregoing structures. Computer-executable instructions comprise, for example, instructions and data that cause a general purpose computer, special purpose computer, or special purpose processing device to execute a certain function or group of functions. The computer-executable instructions and associated data structures represent an example of program code means for executing the steps of the invention disclosed herein.

The invention further extends to computer systems adapted for use with distributed memory cells and related server technology, as described herein. Those skilled in the art will understand that the invention may be practiced in computing environments with many types of computer system configurations, including personal computers, multi-processor systems, network PCs, minicomputers, mainframe computers, and the like. The invention will be described herein in reference to a distributed computing environment, such as the Internet, where tasks are performed by remote processing devices that are linked through a communications network. In the distributed computing environment, computer-executable instructions and program modules for performing the features of the invention may be located in both local and remote memory storage devices.

The present invention may be embodied in other specific forms without departing from its spirit or essential characteristics. The described embodiments are to be considered in all respects only as illustrative and not restrictive. The following claims are presented to illustrate various novel features of the present invention. The claims are not exhaustive of the embodiments of the invention, nor are they to be construed as limiting the scope of the invention. Moreover, the invention disclosed in detail herein can be defined with other claims, including those that will be included in any related non-provisional applications that will be filed during the pendency of this provisional application.

We claim:

1. In a cell-oriented data system in which memory cells contain data, a method for storing data in the memory cells, comprising:
receiving at least one datum for storage in the data system;
storing the datum in a variable cell that is configured for storing data; and
assigning at least one of a plurality of cell data type descriptions to the variable cell.

2. A method as defined in claim 1, further comprising the act of linking the variable cell to at least one directory cell and at least one linking cell, wherein the directory cell and the linking cell are used to group a plurality of cells in a hierarchical order.

3. A method as defined in claim 2, further comprising the act of linking the directory cell to at least one proxy cell that includes information for locating at least one datum stored at data storage device separate from the data storage device storing the at least one datum stored in the variable cell.

4. A method as defined in claim 1, further comprising assigning at least one attribute to the variable cell.

5. A method as defined in claim 1, wherein the system is available as a web based service.

6. A method as defined in claim 1, further comprising assigning a name to the variable cell that represents a unique pathname to the cell.

7. A method as defined in claim 1, wherein the act of receiving at least one datum for storage in the data system further comprises storing the datum in a data system having a modular architecture that allows extending the functionality of the data system to add additional control modules.

8. In a cell-oriented data system, in which memory cells contain data, a method for providing a subscription service that enables users to access the data, comprising:
granting a subscriber access to the cell-based communication system;
assigning a uniform resource identifier (URI) as an address that represents a datum stored in a memory cell of the cell-oriented data system; and
in response to receiving a request that includes the URI, transmitting the requested datum using a web server to a communication device operated by the subscriber.

9. A method as defined in claim 8, further comprising the act of, using a computerized system associated with the cell-oriented data system, performing a financial transaction by which the subscriber pays for accessing the requested datum.

10. A method as defined in claim 8, wherein the datum comprises a real-time datum that has been updated at the memory cell.

11. A method as defined in claim 8, wherein the request has been initiated by the communication device operated by the subscriber using a hypertext transfer protocol.

12. A method as defined in claim 8, wherein the request has been initiated in response to an event, such that the datum is transmitted to the communication device operated by the subscriber without the communication device having made a specific request.

13. A method as defined in claim 9, wherein the financial transaction is performed on the basis of one of:
a particular amount of money per accessible memory cell;
a periodic subscription fee;
the right to access to specific content in a cell;
each instance of access of a cell;
initiating the request for purposes of accessing the datum; and
the ability to update the datum.

14. A method as defined in claim 8, wherein transmitting the requested datum to the communication device comprises sending the datum to the communication device using a hypertext transfer protocol.

15. A method as defined in claim 8, wherein transmitting the requested datum to the communication device comprises sending the datum to the communication device via e-mail.

16. A method as defined in claim 8, wherein the URI becomes valid when the memory cell is created and remains operational while the cell exists.

17. A method as defined in claim 8, wherein the memory cell contains administrative information, including at least one of the identity of a subscriber who has access to the memory cell and a time of the last change of the datum contained in the memory cell.

18. A method as defined in claim 8, wherein the datum has a specified lifetime, after which the datum is no longer accessible.

19. A method as defined in claim 8, wherein granting the subscriber access to the cell-based communication system is performed by one of a mobile telephone service provider, a telecom service provider, a internet service provider, an application service provider, and a business integrator.

20. A method as defined in claim 8, wherein the datum has one of an integer data type, a floating-point data type, a text data type, an audio data type, and a video data type.

21. A method as defined in claim 8, further comprising providing subscription control for the memory cell, and includes one or more properties for accessing, reading of, or writing to the memory cell.

22. A method as defined in claim 21, wherein the subscription control comprises access control based on at least one of a user attribute, a time attribute, a frequency attribute, read permission, write permission and delete permission.

23. A method as defined in claim 8, further comprising maintaining a history for the memory cell, wherein at least one of the size, number of records, and time of the history is configurable.

24. A method as defined in claim 8, wherein the communication device operated by the subscriber comprises a networked computing device and is one of:
a personal computer;
a handheld personal computer;
a personal digital assistant;
a mobile telephone;
a server based navigation system; and
a device with an embedded system having network access.

25. A method as defined in claim 24, further comprising displaying the datum at the communication device using a standard format.

26. A method as defined in claim 25, wherein the standard format is associated with HTTP or HTTPS.

27. A method as defined in claim 8, wherein the memory cell includes a user interface description that specifies display methods that are to be used to display the datum at the communication device.

28. In a cell-oriented data system in which memory cells contain data, a computer program product for implementing a method suitable for storing data in the memory cells, the computer program product comprising:
a computer readable medium carrying computer executable instructions for performing the method, wherein the method comprises:
storing at least one datum in a variable cell that is configured for storing data;
assigning at least one of a plurality of cell data type descriptions to the variable cell;
assigning a uniform resource identifier (URI) as an address that represents the datum within the cell-oriented data system; and
linking the variable cell to at least one directory cell and at least one linking cell, wherein the directory cell and the linking cell are used to group a plurality of cells in a hierarchical order.
